(19) United States
(12) Patent Application Publication
(10) Pub. No.: US 2009/0135510 A1
(43) Pub. Date: May 28, 2009

(54) REFLECTIVE PROJECTION OPTICAL SYSTEM, EXPOSURE APPARATUS, DEVICE MANUFACTURING METHOD, PROJECTION METHOD, AND EXPOSURE METHOD

(76) Inventors: Takuro Ono, Okegawa-shi (JP); Hiroshi Chiba, Ageo-shi (JP); Hideki Komatsuda, Ageo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/323,274

(22) Filed: Nov. 25, 2008

(30) Foreign Application Priority Data
Nov. 26, 2007 (JP) P2007-305066

(51) Int. Cl. G02B 17/06

(52) U.S. Cl. 359/858

(57) ABSTRACT

A reflective projection optical system comprises a first optical unit having at least one reflecting optical element, and a second optical unit having at least one reflecting optical element. A focal point on the second surface side of the first optical unit approximately agrees with a focal point on the first surface side of the second optical unit. An angle between a normal to the first surface and a principal ray of the illumination beam incident to the first surface is larger than a value of arcsine of a numerical aperture on the first surface side of the reflective projection optical system. All the optical elements in the projection optical system are located outside an extension surface of a ray group defining an outer edge of the illumination beam incident to the first surface.

### CROSS-REFERENCE TO RELATED APPLICATIONS

This application is based upon and claims the benefit of priorities from Japanese Patent Application No. 2007-305066 filed on Nov. 26, 2007, the entire contents of which are incorporated herein by reference.

### BACKGROUND OF THE INVENTION

1. Field

An embodiment of the present invention relates to a reflective projection optical system, an exposure apparatus, and a device manufacturing method.

2. Description of the Related Art

In recent years, requirements for downsizing of electronic equipment have increased the demands for miniaturization of semiconductor devices. For meeting the demands for miniaturization of semiconductors, decrease in a wavelength of a radiation source is being studied with exposure apparatus. However, the decrease in the wavelength results in increase in absorption of radiation, so as to limit types of optical glass applicable to practical use. For this reason, there are studies on a projection optical system with reflecting optical elements (e.g., Katsura Otaki: Jpn. Appl. Phys. Vol. 39 (2000) pp. 6819-6826: Asymmetric Properties of the Aerial Image in Extreme Ultraviolet Lithography).

An exposure apparatus under research is configured to illuminate a pattern formed on a reflective reticle and project an image of the pattern on the reticle onto a photosensitive substrate. With the reflective reticle, oblique illumination is applied in order to separate radiation incident to the reticle from radiation reflected on the reticle and entering the projection optical system.

### SUMMARY

An embodiment of the present invention provides a reflective projection optical system configured to project an image of a first surface onto a second surface with reflected radiation on the first surface illuminated with illumination radiation, the reflective projection optical system being substantially telecentric on both of the first surface side and the second surface side.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessary achieving other advantages as may be taught or suggested herein.

A reflective projection optical system according to an aspect is a reflective projection optical system which projects an image of a first surface onto a second surface with reflected radiation on the first surface illuminated with an illumination beam from an illumination optical system, the projection optical system comprising: a first optical unit comprising at least one reflecting optical element; and a second optical unit comprising at least one reflecting optical element, wherein a focal point on the second surface side of the first optical unit substantially agrees with a focal point on the first surface side of the second optical unit, wherein an angle between a normal to the first surface and a principal ray of the illumination beam incident to the first surface is larger than a value of arcsine of a numerical aperture on the first surface side of the reflective projection optical system, and wherein all the optical elements in the projection optical system are located outside an extension surface of a ray group defining an outer edge of the illumination beam incident to the first surface.

An exposure apparatus according to another aspect is an exposure apparatus which projects an image of a first surface onto a second surface, the exposure apparatus comprising: an illumination optical apparatus to illuminate the first surface; and the above-described reflective projection optical system.

A device manufacturing method according to another aspect is a device manufacturing method comprising: preparing a photosensitive substrate; arranging the photosensitive substrate on the second surface in the exposure apparatus as set forth in claim 8, and projecting an image of a predetermined pattern located at the first surface, onto the photosensitive substrate to effect exposure thereof; developing the photosensitive substrate onto which the image of the pattern on the mask has been projected, to form a mask layer in a shape corresponding to the pattern on a surface of the photosensitive substrate; and processing the surface of the photosensitive substrate through the mask layer.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a configuration diagram schematically showing an exposure apparatus according to an embodiment.

FIG. 2 is a configuration diagram of a projection optical system in the exposure apparatus according to the embodiment.

FIG. 3 is a diagram for explaining an angle between a normal to a reticle and a principal ray of a beam incident to the reticle.

FIG. 4 is a drawing schematically showing optical paths in the vicinity of the reticle.

FIG. 5 is a flowchart of a manufacturing method of semiconductor devices.

FIG. 6 is a configuration diagram of a projection optical system according to a first example.

FIG. 7 is a drawing showing the radius of curvature at the top and the surface separation of each of reflecting surfaces in the projection optical system according to the first example.

FIG. 8 is a drawing showing aspheric data of each of surfaces in the projection optical system according to the first example.

FIG. 9 is a drawing showing eccentricity data of each of surfaces in the projection optical system according to the first example.

FIG. 10 is a drawing showing positions on an arcuate exposure region formed on a wafer.

FIG. 11 is a drawing showing coordinates of positions of respective points on the exposure region of the wafer.

FIG. 12A is a drawing showing M-directional cosine and L-directional cosine of angles between a principal ray and each of rays arriving at respective points on the exposure region.

FIG. 12B is a drawing showing M-directional cosine and L-directional cosine of angles between a principal ray and each of rays arriving at respective points on the exposure region.

FIG. 13 is a drawing showing differences between a maximum and a minimum of M-directional cosine and differences between a maximum and a minimum of L-directional cosine, for the points on the exposure region.

FIG. 14A is a drawing for explaining an M-directional cosine.

FIG. 14B is a drawing for explaining an L-directional cosine.

FIG. 15 is a configuration diagram of a projection optical system according to a second example.

FIG. 16 is a drawing showing the radius of curvature at the top and the surface separation of each of reflecting surfaces in the projection optical system according to the second example.

FIG. 17 is a drawing showing aspheric data of each of surfaces in the projection optical system according to the second example.

FIG. 18 is a drawing showing eccentricity data of each of surfaces in the projection optical system according to the second example.

FIG. 19 is a drawing showing coordinates of positions of respective points on the exposure region of the wafer.

FIG. 20A is a drawing showing M-directional cosine and L-directional cosine of angles between a principal ray and each of rays arriving at respective points on the exposure region.

FIG. 20B is a drawing showing M-directional cosines and L-directional cosines of angles between a principal ray and rays arriving at respective points on the exposure region.

FIG. 21 is a drawing showing differences between a maximum and a minimum of M-directional cosine and differences between a maximum and a minimum of L-directional cosine, for the points on the exposure region.

### DESCRIPTION

Embodiments will be described below in detail with reference to the accompanying drawings. In the description, the same elements or elements with the same functionality will be denoted by the same reference symbols, without redundant description.

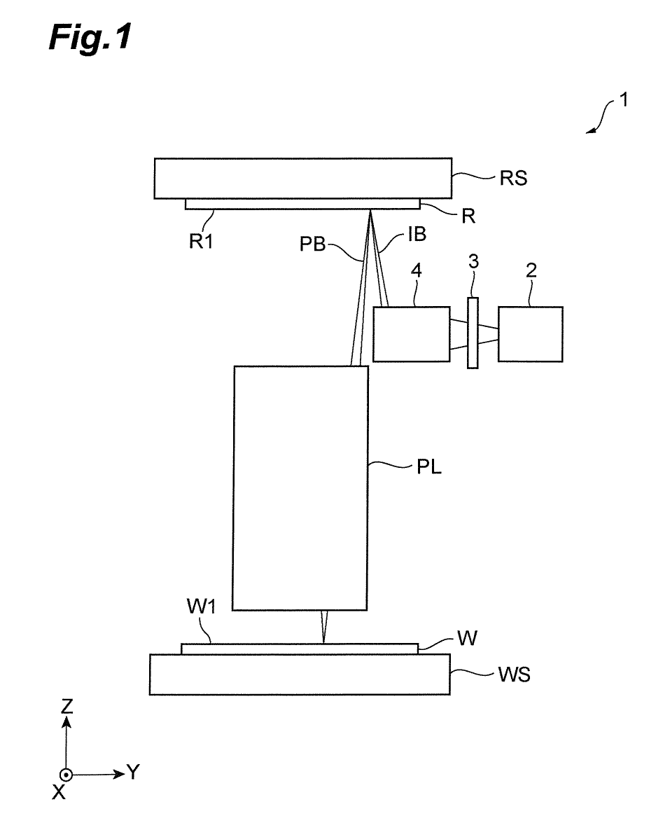

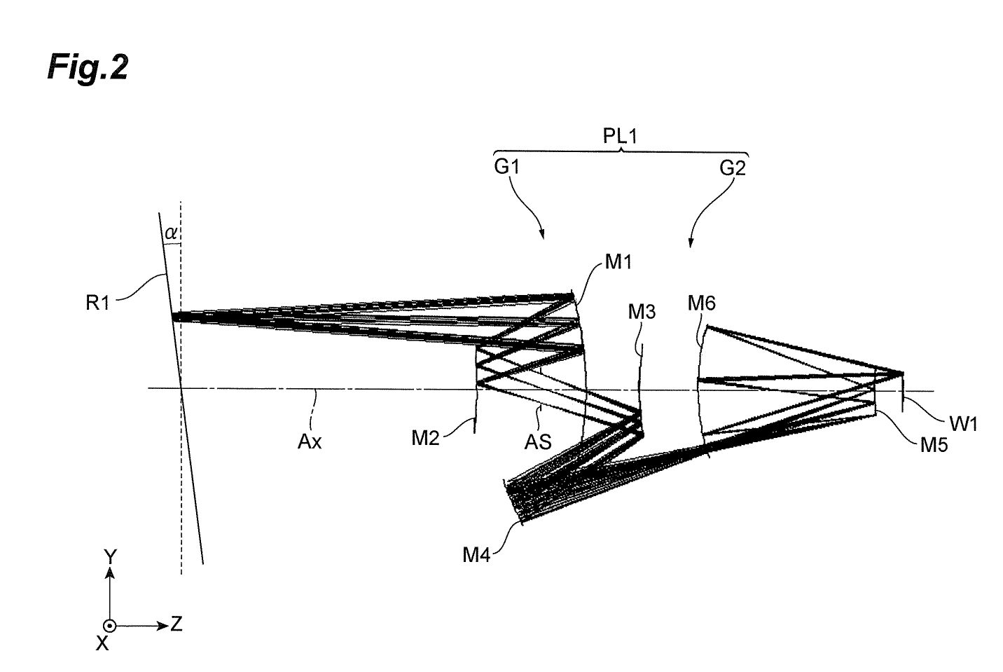

FIG. 1 is a drawing schematically showing a configuration of an exposure apparatus 1 according to an embodiment of the present invention. FIG. 2 is a drawing showing a configuration of a projection optical system PL in the exposure apparatus 1. In FIG. 1, the Z-axis is set along a direction of a reference optical axis of the projection optical system PL, the Y-axis along a direction parallel to the plane of FIG. 1 in a plane perpendicular to the reference optical axis of the projection optical system PL, and the X-axis along a direction normal to the plane of FIG. 1 in the plane perpendicular to the later-described reference optical axis Ax of the projection optical system PL.

The exposure apparatus 1 of the first example has a wavelength-selective filter 3, an illumination optical system 4, a reticle stage RS supporting a reticle (mask) R, a projection optical system PL, and a wafer stage WS supporting a wafer W. The exposure apparatus 1 is configured to illuminate the reticle R with radiation having been emitted from the EUV radiation source 2 and having traveled via the wavelength-selective filter 3 and the illumination optical system 4, and to project an image of a first surface being a pattern surface R1 on which a pattern of the reticle R is formed, onto a second surface being a projection surface W1 on the wafer W, using the projection optical system PL. The first surface can be assumed as a virtual surface at the position of which the pattern surface R1 of the reticle R is to be placed. The second surface can be assumed as a virtual surface at the position of which the surface of the wafer W is to be placed, or as an image surface formed by the projection optical system PL.

As shown in FIG. 1, a discharge plasma radiation source that emits EUV (Extreme UltraViolet) radiation having the wavelength of 13.5 nm is used as the EUV radiation source 2 for supplying exposure radiation, for example. However, the EUV radiation source 2 may also be, for example, a discharge plasma radiation source that emits EUV radiation of a wavelength different from 13.5 nm. Other examples of the EUV radiation source 2 applicable herein include a laser plasma radiation source, a synchrotron radiation source, and so on.

The radiation emitted from the EUV radiation source 2 travels through the wavelength-selective filter 3 to enter the illumination optical system 4. The wavelength-selective filter 3 herein has a property to selectively transmit only an X-ray of a predetermined wavelength (e.g., 13.5 nm) and block radiation of the other wavelengths, out of the radiation supplied from the EUV radiation source 2.

The EUV radiation transmitted by the wavelength-selective filter 3 then travels via the illumination optical system 4 composed of a plurality of reflecting mirrors, to illuminate the reflective reticle R on which the pattern to be transferred is formed. For implementing ray separation between radiation IB traveling toward the reticle R and radiation PB reflected on the reticle R and traveling toward the projection optical system PL, the exposure apparatus 1 is configured to make the illumination radiation obliquely incident to the reticle R (oblique illumination).

The reticle R is so arranged that a direction of a normal to the pattern surface R1 with the pattern thereon disagrees with the reference optical axis Ax of the projection optical system PL. The pattern surface R1 of the reticle R is arranged obliquely relative to the XY plane. The reticle R is held by the reticle stage RS movable along the Y-direction. The exposure apparatus is configured so that movement of the reticle stage RS can be measured by a laser interferometer not shown. In this manner, an arcuate illumination region IR (not shown in FIG. 1) symmetric with respect to the Y-axis is formed on the reticle R.

The radiation PB reflected on the pattern surface R1 of the reticle R illuminated travels via the reflective projection optical system PL to form an image of the pattern surface R1 on the exposure surface W1 of the wafer W being a photosensitive substrate. Namely, an arcuate exposure region symmetric with respect to the Y-axis is formed on the exposure surface W1 of the wafer W.

The wafer W is so arranged that a direction of a normal to the exposure surface W1 disagrees with the reference optical axis Ax of the projection optical system PL and that the direction of the normal to the exposure surface W1 disagrees with the direction of the normal to the reticle R. The exposure surface W1 of the wafer W is arranged obliquely relative to the XY plane. The wafer W is held by the wafer stage WS two-dimensionally movable along the X-direction and the Y-direction. The exposure apparatus is also configured so that movement of the wafer stage WS can be measured by an unrepresented laser interferometer, as in the case of the reticle stage RS. In this manner, the pattern of the reticle R is transferred into one exposure region on the wafer W by carrying out scan exposure (scanning exposure) while moving the reticle stage RS and the wafer stage WS along the Y-direction, i.e., while relatively moving the reticle R and the wafer W along the Y-direction relative to the projection optical system PL.

At this time, where a projection magnification (transfer magnification) of the projection optical system PL is ¼, synchronous scanning is performed under the condition that a moving speed of the wafer stage WS is set at a quarter of a moving speed of the reticle stage RS. The scanning exposure is repeatedly carried out while two-dimensionally moving the wafer stage WS along the X-direction and the Y-direction, whereby the pattern of the reticle R is sequentially transferred into each of exposure regions on the wafer W.

A specific configuration of the projection optical system PL will be described below with reference to FIG. 2. FIG. 2 is a drawing showing the configuration of the projection optical system PL. The projection optical system PL has a first optical unit G1 having at least one reflecting mirror being a reflecting optical element, a second optical unit G2 having at least one reflecting mirror being a reflecting optical element, and an aperture stop AS arranged between the first optical unit G1 and the second optical unit G2 along the optical path. The first optical unit G1 is composed of two reflecting mirrors M1, M2 and the second optical unit G2 is composed of four reflecting mirrors M3, M4, M5, and M6. Namely, the projection optical system PL is a reflective projection optical system composed of the six reflecting mirrors. The aperture stop AS is arranged between the second reflecting mirror M2 and the third reflecting mirror M3 along the optical path from the reticle R.

The first optical unit G1 is composed of the reflecting mirrors M1, M2 located on the reticle side R along the optical path with respect to the aperture stop AS. The second optical unit G2 is composed of the reflecting mirrors M3-M6 located on the wafer side W along the optical path with respect to the aperture stop AS. However, when there is a reflecting mirror a position of which approximately agrees with the position of the aperture stop AS, the reflecting mirror at the position approximately agreeing with that of the aperture stop AS is considered to be excluded from both of the first and second optical units G1, G2 and the other reflecting mirrors are grouped into the units before and after the aperture stop AS.

In the projection optical system PL, the focal point on the wafer W side of the first optical unit G1 approximately agrees with the focal point on the reticle R side of the second optical unit G2. Therefore, the projection optical system PL is an optical system substantially telecentric on both of the reticle R side and the wafer W side.

As shown in FIG. 2, the reflecting mirror M1 is a concave mirror, the reflecting mirror M2 a convex mirror, the reflecting mirror M3 a convex mirror, the reflecting mirror M4 a concave mirror, the reflecting mirror M5 a convex mirror, and the reflecting mirror M6 a concave mirror. The radiation from the reticle R is successively reflected on a reflecting surface of the reflecting mirror M1 and on a reflecting surface of the reflecting mirror M2 and then passes through the aperture stop AS. Thereafter, the radiation is successively reflected on a reflecting surface of the reflecting mirror M3, on a reflecting surface of the reflecting mirror M4, on a reflecting surface of the reflecting mirror M5, and on a reflecting surface of the reflecting mirror M6, to form a reduced image of the reticle pattern on the exposure surface W1 of the wafer W.

The reflecting surfaces of at least one set of reflecting mirrors out of the reflecting mirrors M1-M6 may be formed in an aspheric shape rotationally symmetric with respect to a reference axis as an axis of rotational symmetry. Therefore, the reflecting surfaces of all the reflecting mirrors M1-M6 may be formed in an aspheric shape rotationally symmetric with respect to the reference axis as an axis of rotational symmetry. The reference axis of each of the reflecting mirrors M1-M6 herein refers to an axis that passes a center of curvature at the top of the reflecting surface of the reflecting mirror and that is perpendicular to a tangent plane at the center of curvature. Namely, the reference axis of each of the reflecting mirrors M1-M6 herein refers to an axis that passes the top of the reflecting surface of the reflecting mirror and that is perpendicular to a tangent plane at the top of the reflecting surface.

The reference axes of at least one set of reflecting mirrors out of the reflecting mirrors M1-M6 in the projection optical system PL disagree with each other.

As shown in FIG. 2, the pattern surface R1 of the reticle R is obliquely arranged so that the direction of the normal thereto disagrees with the reference optical axis Ax of the projection optical system PL. Specifically, the pattern surface R1 of the reticle R has a finite angle a to a plane normal to the reference optical axis Ax of the projection optical system PL. The reference optical axis Ax of the projection optical system PL herein refers to an axis that is parallel to a center axis of a barrel of the projection optical system PL and that passes a center position of the aperture stop AS. The angle α is an angle of rotation around the X-axis.

The exposure surface W1 of the wafer W is also obliquely arranged so that the direction of the normal thereto disagrees with the reference optical axis Ax of the projection optical system PL.

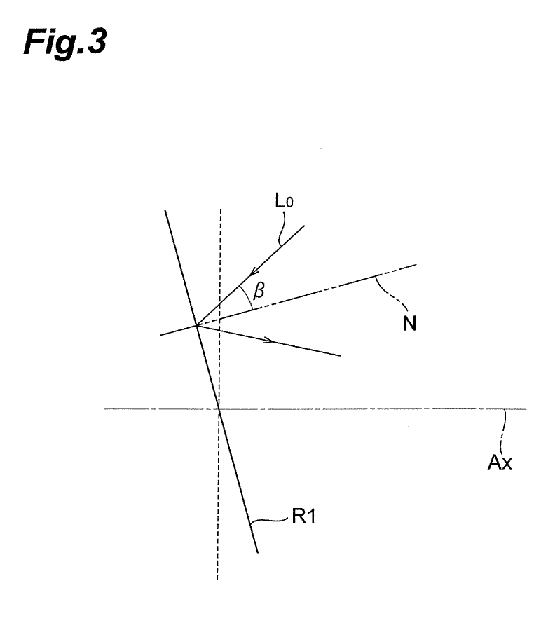

As shown in FIG. 3, an angle β between a normal N to the pattern surface R1 of the reticle R and a principal ray L of the beam incident to the pattern surface R1 is larger than a value of arcsine of the numerical aperture on the reticle R side of the projection optical system PL. Namely, the following relation (1) holds:

β>sin⁻¹(NA) (1),

where NA is the numerical aperture on the reticle R side of the projection optical system PL and the projection optical system PL is assumed to be arranged in an atmosphere having the refractive index of 1 for the wavelength in use (typically, in air or in vacuum).

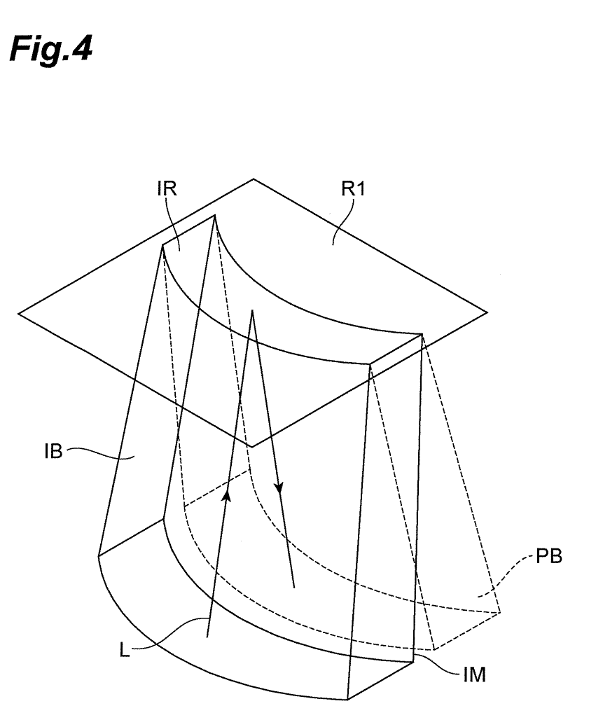

FIG. 4 is a drawing schematically showing the optical path of the illumination beam IB incident to the pattern surface R1 of the reticle R and the optical path of the projection beam PB reflected on the pattern surface R1 and entering the projection optical system PL. As shown in this FIG. 4, when we consider an imaginary surface IM formed by a ray group defining an outer edge of the illumination beam IB incident to the pattern surface R1, the optical elements M1-M6 constituting the projection optical system PL are located only in the space on the opposite side to the side where the illumination beam IB is present, with respect to an extension surface of this imaginary surface IM as a border. In other words, all the optical elements M1-M6 constituting the projection optical system PL are arranged so as to be located outside the extension surface of the ray group defining the outer edge of the illumination beam IB incident to the pattern surface R1.

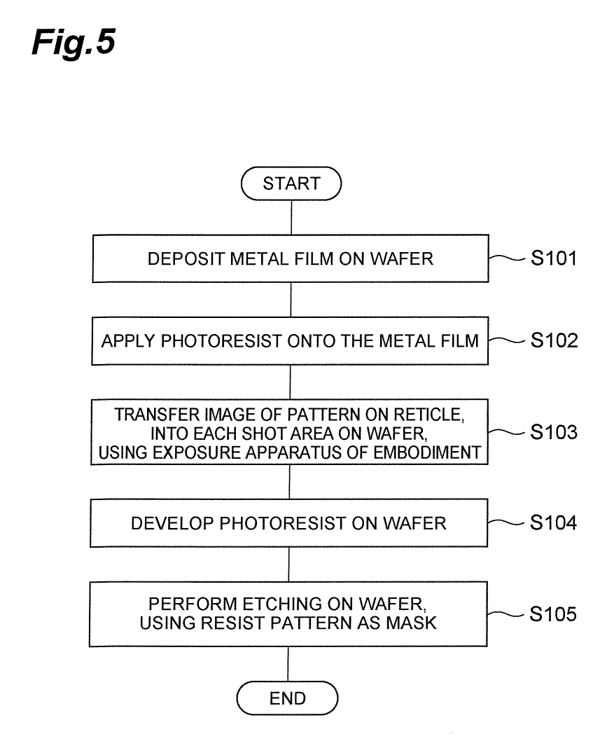

A method of manufacturing devices using the exposure apparatus 1 of the present embodiment will be described below with reference to the flowchart shown in FIG. 5. The first block S101 in FIG. 5 is to deposit a metal film on each wafer W in one lot. The next block S102 is to apply a photoresist onto the metal film on the wafer W in the lot. The subsequent block S103 is to sequentially transfer the image of the pattern on the reticle R into each of shot areas on the wafer W in the lot through the projection optical system, using the exposure apparatus of the present embodiment.

The subsequent block S104 is to perform development of the photoresist on the wafer W in the lot. This block results in forming a mask layer in a shape corresponding to the pattern surface R1 on the exposure surface W1 of the wafer W.

Block S105 is to process the exposure surface W1 of the wafer W through the mask layer formed in block S104. Specifically, etching is performed on the wafer W in the lot, using the resist pattern as a mask, whereby a circuit pattern corresponding to the pattern on the reticle R is formed in each shot area on each wafer W. Thereafter, devices such as semiconductor devices are manufactured through blocks including formation of circuit patterns in upper layers. The semiconductor device manufacturing method permits us to manufacture the semiconductor devices with extremely fine circuit patterns at good throughput.

The exposure apparatus 1 of the present embodiment uses the reflective reticle R and the reflective projection optical system PL, instead of transparent optical materials. It is therefore feasible to project the image of the pattern surface R1 of the reticle R onto the wafer W, for example, using the EUV radiation at the wavelength of about 13.5 nm emitted from the EUV radiation source 2. As a result, the exposure apparatus 1 is able to achieve a notable improvement in its resolving power.

In the projection optical system PL, the focal point on the wafer W side of the first optical unit G1 approximately agrees with the focal point on the reticle R side of the second optical unit G2. Therefore, the projection optical system PL is able to achieve substantial telecentricity on both of the reticle R side and the wafer W side.

In the projection optical system PL, the direction of the normal to the pattern surface R1 of the reticle R disagrees with the direction of the normal to the exposure surface W1 of the wafer W. For this reason, it becomes feasible to realize the telecentricity on both of the reticle R side and the wafer W side, while well suppressing occurring aberration.

In a case where the pattern formed on the pattern surface R1 of the reticle R has a level difference, the illumination radiation is obliquely incident to the level difference, and a shadow due to the level difference of the pattern surface R1 is made in the image of the pattern surface formed on the exposure surface W1. In order to keep the line width of the pattern image formed on the exposure surface W1 of the wafer W, within a determined range, it is common practice to calculate the shadow made by the level-difference pattern structure of the reflective reticle R and adjust the line width of the pattern formed on the reflective reticle R. At this time, when the illumination radiation is incident at various angles to the reticle R, there will be variation in degrees of shadowing in the pattern image and it will be difficult to adjust the line width of the pattern formed on the reflective reticle R. For this reason, the reflective reticle R may be prepared through many steps, which will pose a problem that the reticle R itself becomes expensive.

In contrast to it, the projection optical system PL1 of the exposure apparatus 1 of the present embodiment achieves the substantial telecentricity on both of the reticle R side and the wafer W side. For this reason, even when the pattern formed on the pattern surface R1 of the reticle R has the level difference, the shadow made in the image of the pattern by the level difference can be made uniform. When the shadow of the level-difference pattern formed in the image of the pattern is made uniform, the block of correcting the reticle R can be simplified.

Furthermore, in the projection optical system PL the reference axes of at least one set of reflecting mirrors out of the reflecting mirrors M1-M6 disagree with each other. This configuration makes it feasible to achieve the telecentricity on both of the reticle R side and the wafer W side, while better suppressing occurring aberration.

In the projection optical system PL, at least one set of reflecting mirrors out of the reflecting mirrors M1-M6 are rotationally-symmetric aspheric mirrors and the reference axes of the at least one set of reflecting mirrors are the axes of rotational symmetry of the aspheric mirrors. This configuration makes it feasible to better suppress occurring aberration.

In the projection optical system PL, the angle β between the normal to the pattern surface R1 of the reticle R and the principal ray of the beam incident to the pattern surface R1 of the reticle R is larger than the value of arcsine of the reticle-side numerical aperture NA of the projection optical system PL. Namely, the relation (1) holds. Therefore, it is feasible to well separate the radiation reflected on the pattern surface R1 of the reticle R, even for the width of the beam incident to the projection optical system PL.

All the optical elements M1-M6 constituting the projection optical system PL are arranged so as to be located outside the extension surface of the ray group defining the outer edge of the illumination beam IB incident to the pattern surface R1. Therefore, it is feasible to increase degrees of freedom for the arrangement of the illumination optical system existing in the space on the opposite side to the projection optical system with respect to the border of the extension surface.

The projection optical system PL is composed of the six reflecting mirrors M1-M6 and the aperture stop AS is arranged between the second reflecting mirror M2 and the third reflecting mirror M3 along the optical path from the pattern surface R1 of the reticle. This configuration is able to well suppress distortion and wavefront aberration.

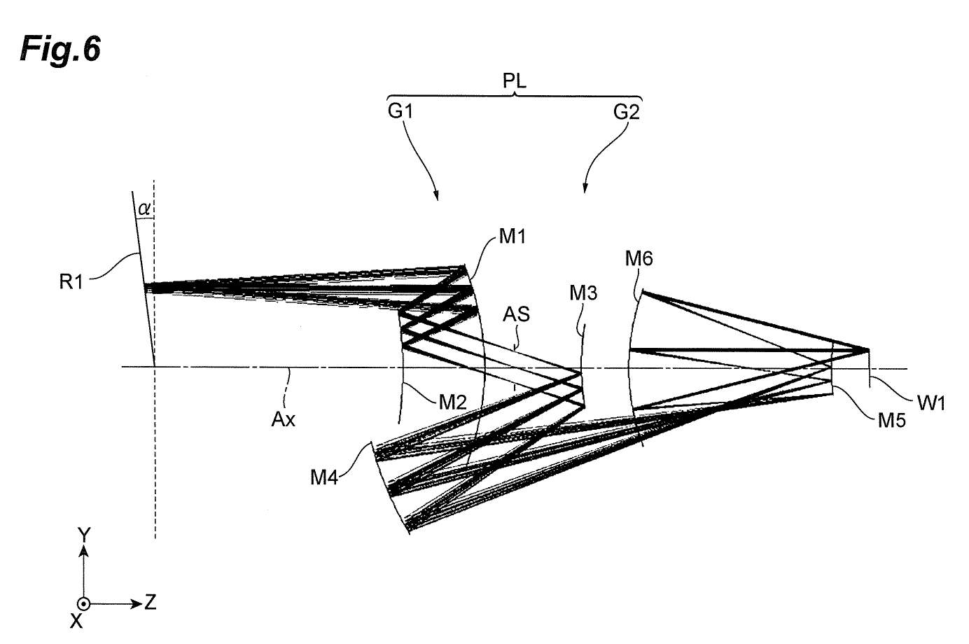

The following will describe a first example of the projection optical system PL as a modification example of the embodiment with reference to FIGS. 6 to 12B. FIG. 6 is a drawing showing the configuration of the projection optical system PL according to the first example.

Referring to FIG. 6, the projection optical system PL of the first example has a first optical unit G1 composed of two reflecting mirrors M1, M2, a second optical unit G2 composed of four reflecting mirrors M3-M6, and an aperture stop AS arranged between the first optical unit G1 and the second optical unit G2 along the optical path. The aperture stop AS is arranged between the second reflecting mirror M2 and the third reflecting mirror M3 along the optical path from the reticle R.

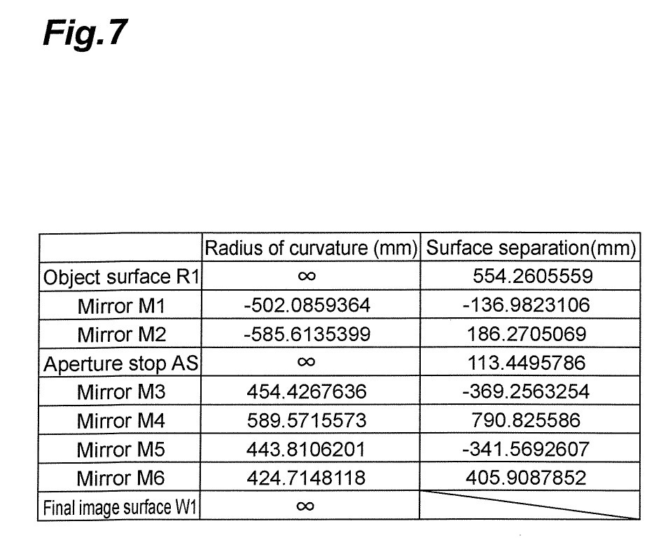

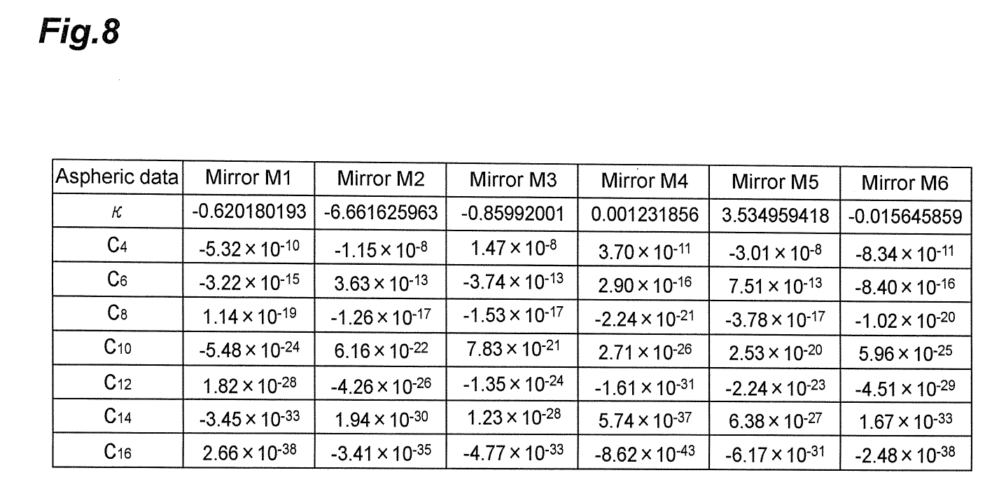

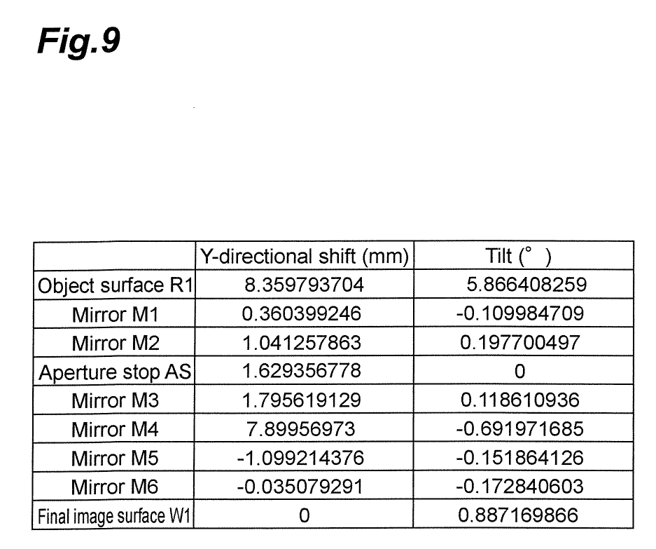

FIGS. 7 to 9 show values of specifications of the projection optical system PL according to the first example. The tables of FIGS. 7 to 9 present the values of specifications of the projection optical system PL according to the first example where the wavelength of the exposure radiation is 13.5 nm, the projection magnification is ¼, and the image-side (wafer-side) numerical aperture is 0.26. FIG. 7 is a table showing the radius of curvature at the top (mm) and the surface separation (mm) of each of the reflecting surfaces in the projection optical system PL according to the first example. FIG. 8 is a table showing the aspheric data of each of the surfaces in the projection optical system PL according to the first example. FIG. 9 is a table showing the eccentricity data of each of the surfaces in the projection optical system PL according to the first example.

The surface separation in the table shown in FIG. 7 refers to an axial spacing (mm) of each reflecting surface. The surface separation is assumed to change its sign every reflection. Furthermore, irrespective of the direction of incidence of ray, the radius of curvature of a convex surface facing the reticle R side is determined to be positive and the radius of curvature of a concave surface facing the reticle R side is determined to be negative. The object surface in FIG. 7 refers to the pattern surface R1 of the reticle R and the final image surface is the exposure surface W1 of the wafer W.

As seen from FIG. 7, the reflecting mirror M1 is a concave mirror, the reflecting mirror M2 a convex mirror, the reflecting mirror M3 a convex mirror, the reflecting mirror M4 a concave mirror, the reflecting mirror M5 a convex mirror, and the reflecting mirror M6 a concave mirror.

In the projection optical system PL of the first example, the reflecting surface of every reflecting mirror M1-M6 is formed in an aspheric shape rotationally symmetric with respect to the reference axis. An aspherical surface is represented by Formula (2) below, where y is a height in a direction normal to the reference axis, z a distance along the optical axis from a tangent plane at the top of the aspherical surface to a position on the aspherical surface at the height y, r the radius of curvature at the top, κ the conic coefficient, and Cn the aspheric coefficient of the nth order.

z=(y²/r)/{1+(1−κ)·y²/r²}^{1/2}+C₄·y⁴+C₆·⁶+C₈·y⁸+C₁₀·y¹⁰+ . . . (2)

The values of κ, C₄, C₆, C₈, C₁₀, C₁₂, C₁₄, and C₁₆ presented as the aspheric data in FIG. 8 are values of the coefficients in the case where each reflecting surface is represented by Formula (2) above.

The eccentricity data in FIG. 9 indicates a shift (mm) in the Y-direction of the center of curvature of the reflecting surface of each reflecting mirror M1-M6 and a tilt (°) being an angle of inclination of the axis of rotational symmetry of each aspherical surface with respect to the Y-direction.

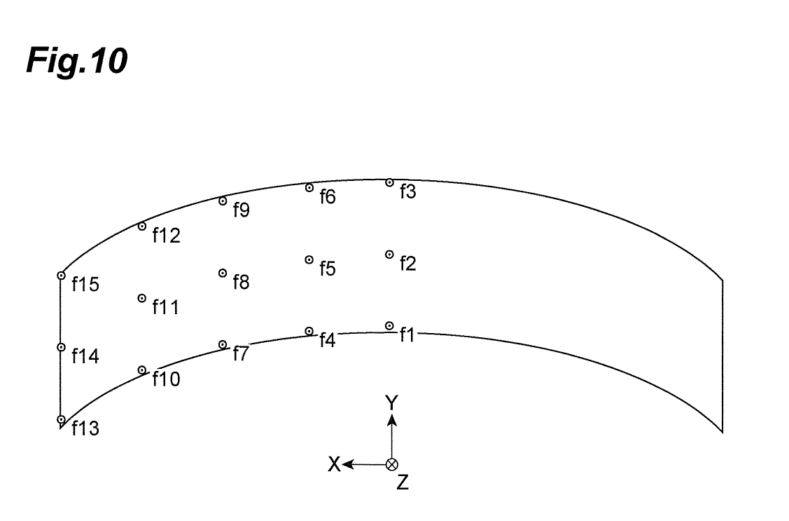

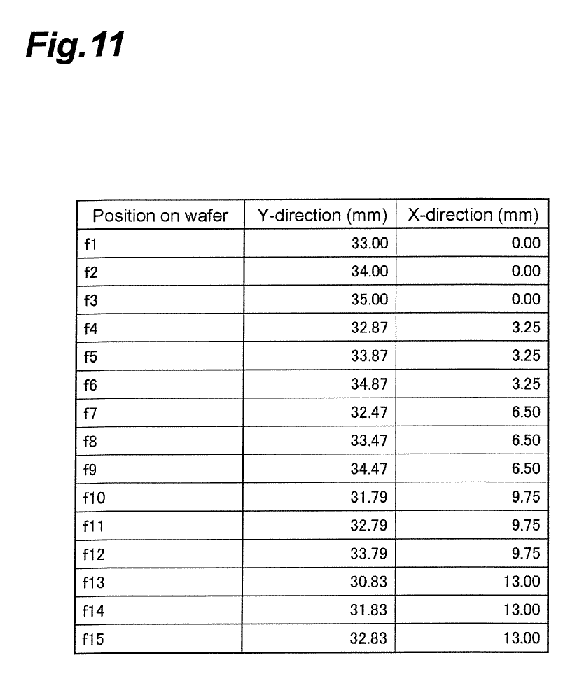

Next, FIG. 10 shows a part ER of the exposure region obtained on the exposure surface W1 in the case where the pattern surface R1 of the reticle R is projected onto the wafer W, using the projection optical system PL of the first example. As shown in FIG. 10, an arcuate exposure region symmetric with respect to the Y-axis is formed. FIGS. 11 to 13 show tables of the results of ray tracing for rays arriving at points f1-f15 on the exposure region ER shown in FIG. 10.

The table of FIG. 11 shows the positions of the respective points f1-f15 on the exposure region ER of the wafer W. The origin is set at a position of a center of an arc including the exposure region ER.

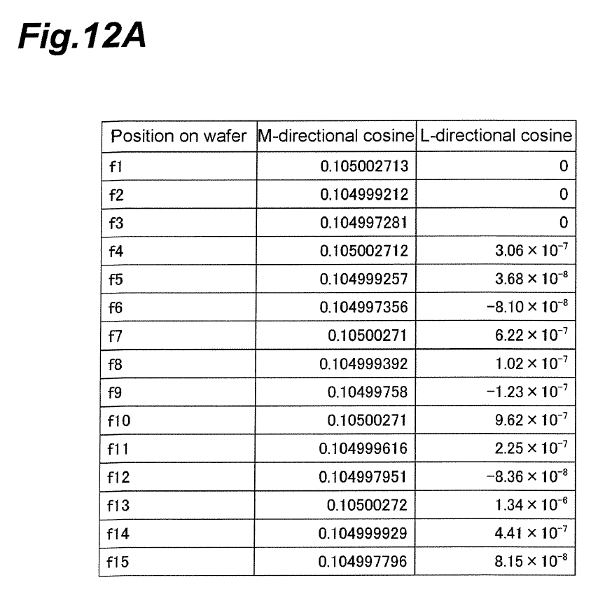

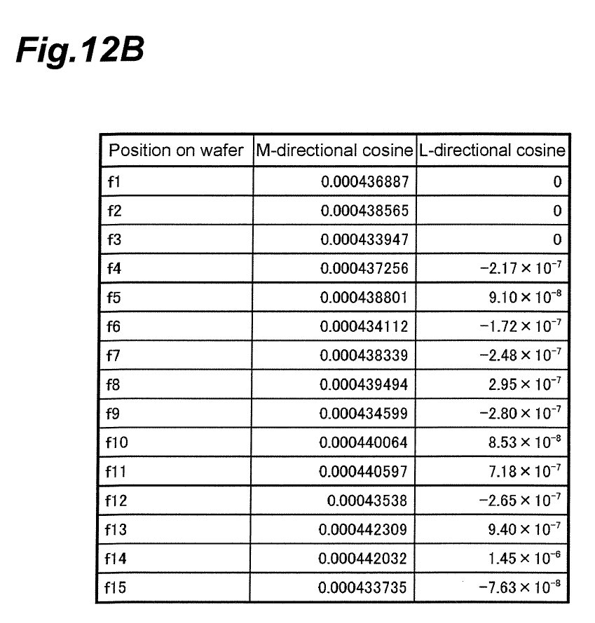

The table of FIG. 12A shows M-directional cosine and L-directional cosine on the reticle R side for each of the rays arriving at the respective points f1-f15 on the exposure region ER with respect to the principal ray L₀. The table of FIG. 12B shows M-directional cosine and L-directional cosine on the wafer W side for each of the rays arriving at the respective points f1-f15 on the exposure region ER with respect to the principal ray L₀.

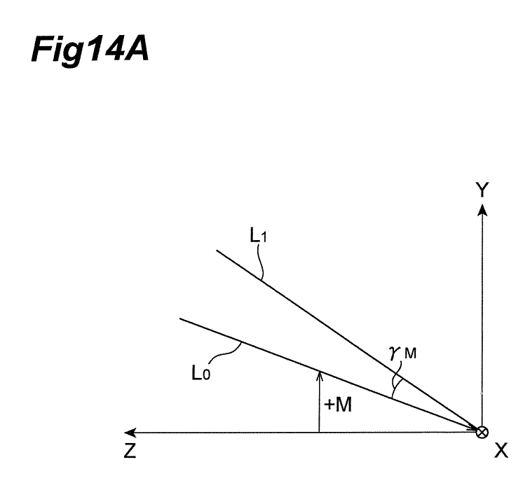

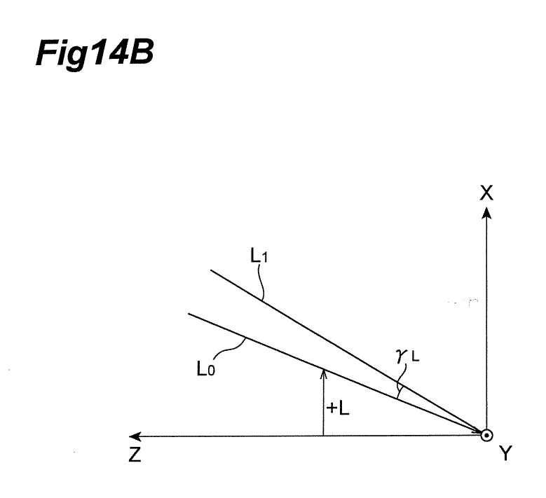

The M-directional cosine and L-directional cosine will be explained below with reference to FIGS. 14A and 14B. FIG. 14A is a drawing to illustrate the M-directional cosine. FIG. 14B is a drawing to illustrate the L-directional cosine. As shown in FIG. 14A, the M-directional cosine is a cosine of a Y-directional inclination angle γ_{M} of a ray L₁ arriving at each point f1-f15, with respect to the principal ray L₀. The direction of an arrow denoted by +M in FIG. 14A indicates the positive direction of M-directional cosine. As shown in FIG. 14B, the L-directional cosine represents a cosine of an X-directional inclination angle γ_{L} of a ray L₁ arriving at each point f1-f15, with respect to the principal ray L₀. The direction of an arrow denoted by +L in FIG. 14B indicates the positive direction of L-directional cosine.

Therefore, it can be said that the closer to each other the values of M-directional cosine and L-directional cosine among the points f1-f15 in the table of FIG. 12A, the better the telecentricity achieved on the reticle side of the projection optical system PL of the first example. It can also be said that the closer to each other the values of M-directional cosine and L-directional cosine among the points f1-f15 in the table of FIG. 12B, the better the telecentricity achieved on the wafer side of the projection optical system PL of the first example.

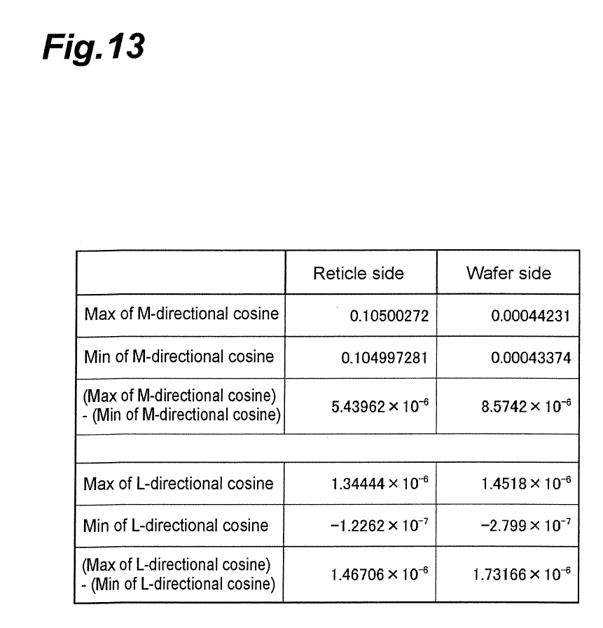

The table of FIG. 13 shows the degree of telecentricity on the reticle side of the projection optical system PL of the first example and the degree of telecentricity on the wafer side of the projection optical system PL of the first example. Namely, from FIG. 12A, a maximum of the M-directional cosine on the reticle side is the value 1.0500272 at the point f13, and a minimum of the M-directional cosine on the reticle side is the value 0.104997280548 at the point f3. Therefore, a difference between the maximum of the M-directional cosine (1.0500272) and the minimum of the M-directional cosine (0.104997280548) is 5.43962×10⁻⁶. Furthermore, from FIG. 12A, a maximum of the L-directional cosine on the reticle side is the value 1.34×10⁻⁶ at the point f13 and a minimum of the L-directional cosine on the reticle side is the value −1.23×10⁻⁷ at the point f9. Therefore, a difference between the maximum of the L-directional cosine (1.34×10⁻⁶) and the minimum of the L-directional cosine (−1.23×10⁻⁷) is 1.463×10⁻⁶.

In the projection optical system PL, as shown in FIG. 13, the difference between the maximum and minimum of the M-directional cosine and the difference between the maximum and minimum of the L-directional cosine on the reticle side both are very small. This is also evident, for example, from the fact that these values become of approximately 10⁻² order in an optical system telecentric only on the wafer side.

From FIG. 12B, a maximum of the M-directional cosine on the wafer side is the value 0.000442309 at the point f13 and a minimum of the M-directional cosine on the wafer side is the value 0.000433735 at the point f15. Therefore, a difference between the maximum of the M-directional cosine (0.000442309) and the minimum of the M-directional cosine (0.000433735) is 8.574×10⁻⁶. From FIG. 12B, a maximum of the L-directional cosine on the wafer side is the value 1.45×10⁻⁶ at the point f14 and a minimum of the L-directional cosine on the wafer side is the value −2.80×10⁻⁷ at the point f9. Therefore, a difference between the maximum of the L-directional cosine (1.45×10⁻⁶) and the minimum of the L-directional cosine (−2.80×10⁻⁷) is 1.73×10⁻⁶.

In the projection optical system PL, as shown in FIG. 13, the difference between the maximum and minimum of the M-directional cosine and the difference between the maximum and minimum of the L-directional cosine on the wafer side both are very small. It is, therefore, also understood from FIG. 13 that the projection optical system PL of the first example is achieved as an optical system substantially telecentric on both of the reticle side and the wafer side.

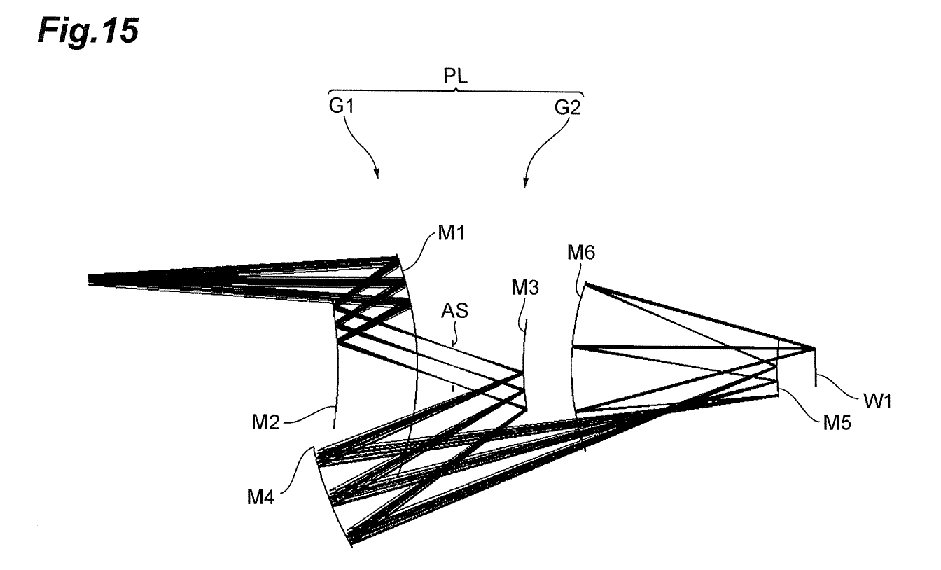

The following will describe a second example of the projection optical system PL as a modification example of the embodiment with reference to FIGS. 15 to 21. FIG. 15 is a drawing showing the configuration of the projection optical system PL according to the second example.

Referring to FIG. 15, the projection optical system PL of the second example has a first optical unit G1 composed of two reflecting mirrors M1, M2, a second optical unit G2 composed of four reflecting mirrors M3-M6, and an aperture stop AS arranged between the first optical unit G1 and the second optical unit G2 along the optical path. The aperture stop AS is arranged between the second reflecting mirror M2 and the third reflecting mirror M3 along the optical path from the reticle R.

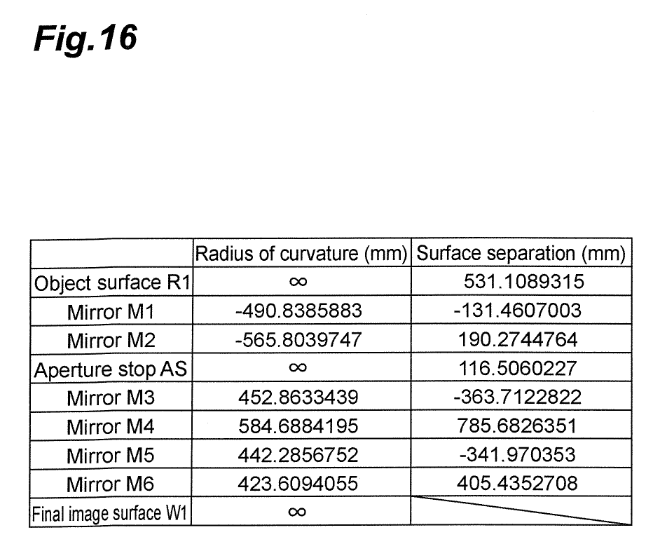

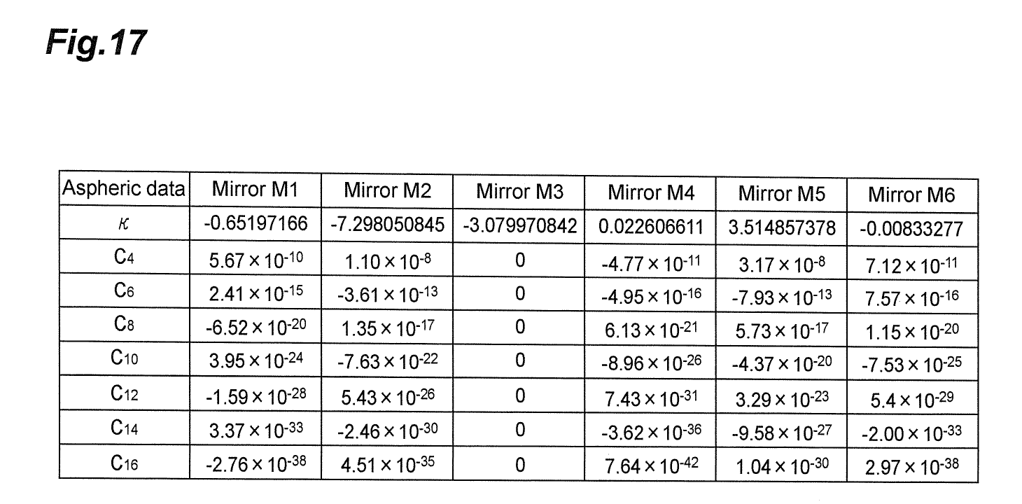

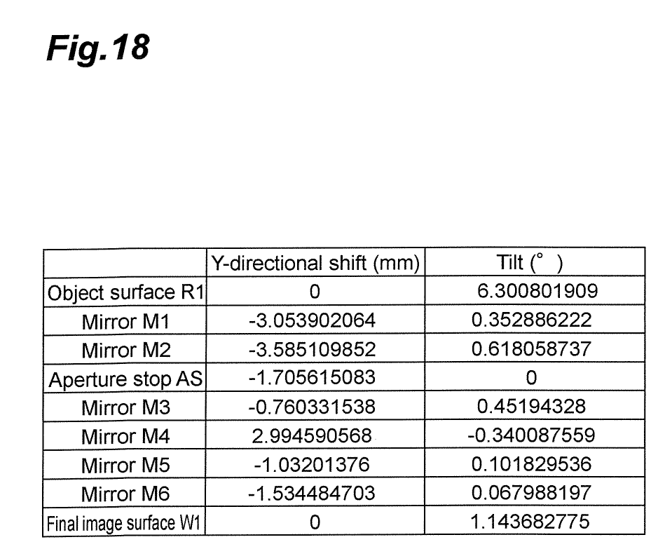

FIGS. 16 to 18 show the values of specifications of the projection optical system PL according to the second example. Tables of FIGS. 16 to 18 present the values of specifications of the projection optical system PL according to the second example where the wavelength of the exposure radiation is 13.5 nm, the projection magnification is ¼, and the image-side (wafer-side) numerical aperture is 0.26. FIG. 16 is a table showing the radius of curvature at the top (mm) and the surface separation (mm) of each of the reflecting surfaces in the projection optical system PL according to the second example. FIG. 17 is a table showing the aspheric data of each of the surfaces in the projection optical system PL according to the second example. FIG. 18 is a table showing the eccentricity data of each of the surfaces in the projection optical system PL according to the second example.

The surface separation in the table shown in FIG. 16 refers to an axial spacing (mm) of each reflecting surface. As seen from FIG. 16, the reflecting mirror M1 is a concave mirror, the reflecting mirror M2 a convex mirror, the reflecting mirror M3 a convex mirror, the reflecting mirror M4 a concave mirror, the reflecting mirror M5 a convex mirror, and the reflecting mirror M6 a concave mirror.

In the projection optical system PL of the second example, the reflecting surface of every reflecting mirror M1-M6 is of an aspheric shape rotationally symmetric with respect to the reference axis and is expressed by Formula (2). The values of κ, C₄, C₆, C₈, C₁₀, C₁₂, C₁₄, and C₁₆ shown as the aspheric data in FIG. 17 are values of the coefficients in the case where each reflecting surface is represented by Formula (2) above.

The eccentricity data in FIG. 18 indicates a shift (mm) in the Y-direction of the center of curvature of the reflecting surface of each reflecting mirror M1-M6 and a tilt (°) being an angle of Y-directional inclination of the axis of rotational symmetry of the aspherical surface.

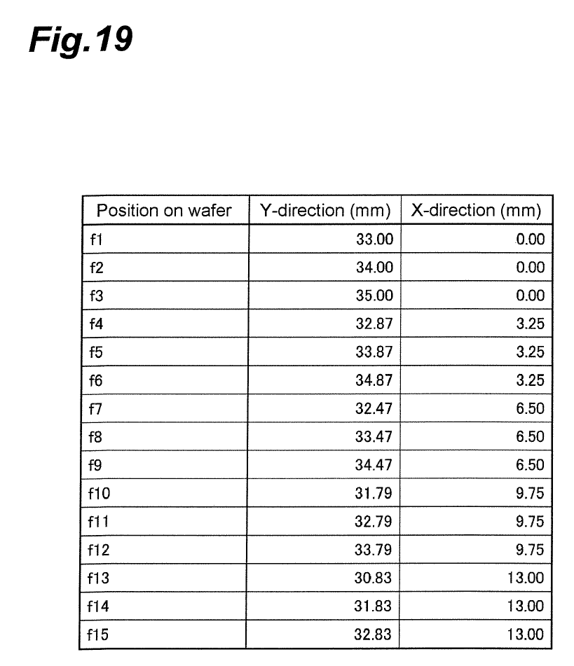

FIGS. 19 to 21 show tables of the results of ray tracing through reflection in the projection optical system PL of the second example, for rays arriving at the points f1-f15 on the exposure region ER shown in FIG. 10. The table of FIG. 19 shows the positions of the respective points f1-f15 on the exposure region ER of the wafer W. The origin is set at a position of a center of an arc including the exposure region ER.

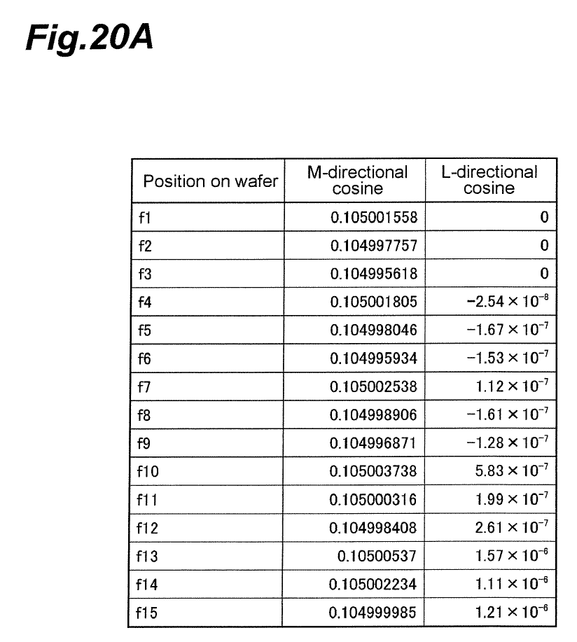

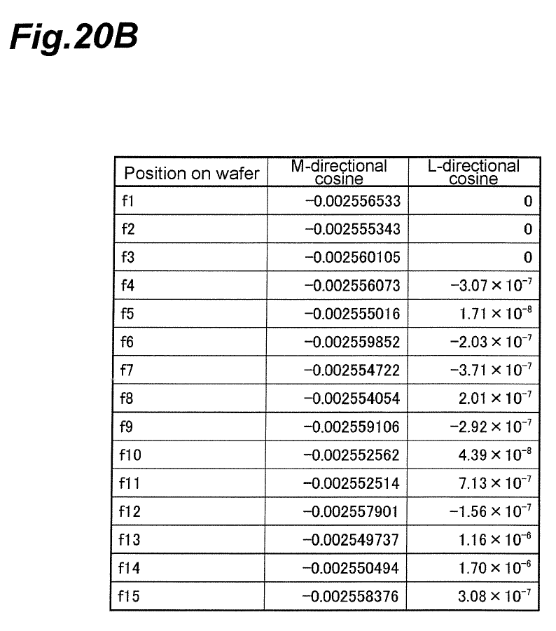

The table of FIG. 20A shows the M-directional cosine and L-directional cosine on the reticle R side for each of the rays arriving at the respective points f1-f15 on the exposure region ER with respect to the principal ray. The table of FIG. 20B shows the M-directional cosine and L-directional cosine on the wafer W side for each of the rays arriving at the respective points f1-f15 on the exposure region ER with respect to the principal ray. It can be said that the closer to each other the values of M-directional cosine and L-directional cosine among the points f1-f15 in the table of FIG. 20A, the better the telecentricity achieved on the reticle side of the projection optical system PL of the second example. It can also be said that the closer to each other the values of M-directional cosine and L-directional cosine among the points f1-f15 in the table of FIG. 20B, the better the telecentricity achieved on the wafer side of the projection optical system PL of the second example.

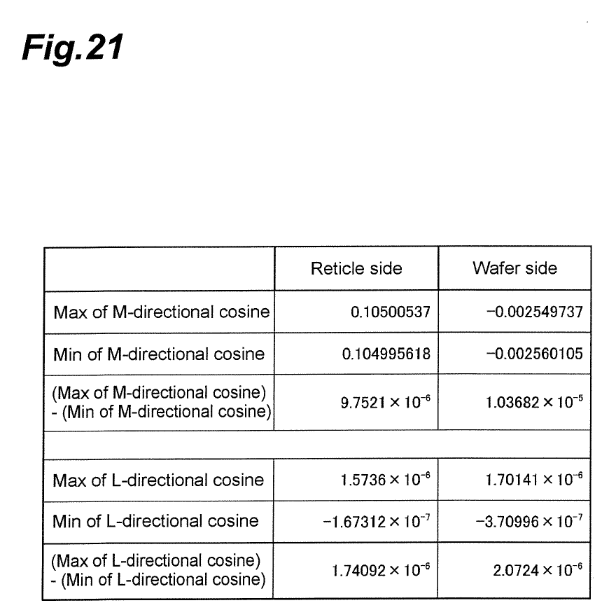

The table of FIG. 21 shows the degree of telecentricity on the reticle side of the projection optical system PL of the second example and the degree of telecentricity on the wafer side of the projection optical system PL of the second example. Namely, from FIG. 20A, a maximum of the M-directional cosine on the reticle side is the value 0.10500537 at the point f13 and a minimum of the M-directional cosine on the reticle side is the value 0.104995618 at the point f3. Therefore, a difference between the maximum of M-directional cosine (0.10500537) and the minimum of M-directional cosine (0.104995618) is 9.7521×10⁻⁶. Furthermore, from FIG. 20A, a maximum of the L-directional cosine on the reticle side is the value 1.57×10⁻⁶ at the point f13 and a minimum of the L-directional cosine on the reticle side is the value −1.67×10⁻⁷ at the point f5. Therefore, a difference between the maximum of L-directional cosine (1.57×10⁻⁶) and the minimum of L-directional cosine (−1.67×10⁻⁷) is 1.737×10⁻⁶.

In the projection optical system PL, as shown in FIG. 21, the difference between the maximum and minimum of the M-directional cosine and the difference between the maximum and minimum of the L-directional cosine on the reticle side both are very small.

From FIG. 20B, a maximum of the M-directional cosine on the wafer side is the value −0.002549737 at the point f13 and a minimum of the M-directional cosine on the wafer side is the value −0.002560105 at the point f3. Therefore, a difference between the maximum of M-directional cosine (−0.002549737) and the minimum of M-directional cosine (−0.002560105) is 1.03682×10⁻⁵. From FIG. 20B, a maximum of the L-directional cosine on the wafer side is the value 1.70×10⁻⁶ at the point f14 and a minimum of the L-directional cosine on the wafer side is the value −3.71×10⁻⁷ at the point f7. Therefore, a difference between the maximum of L-directional cosine (1.70×10⁻⁶) and the minimum of L-directional cosine (−3.71×10⁻⁷) is 2.071×10⁻⁶.

In the projection optical system PL, as shown in FIG. 21, the difference between the maximum and minimum of the M-directional cosine and the difference between the maximum and minimum of the L-directional cosine on the wafer side both are very small. It is, therefore, also understood from FIG. 21 that the projection optical system PL of the second example is realized as an optical system substantially telecentric on both of the reticle side and the wafer side.

Thus, embodiments and modifications of the present invention can provide the reflective projection optical system configured to project the image of the first surface onto the second surface with the reflected radiation on the first surface illuminated with the illumination radiation, the reflective projection optical system being substantially telecentric on both of the first surface side and the second surface side.

The above described the embodiment, but it should be noted that the present invention is by no means intended to be limited to the above embodiment and examples but can be modified in many ways. For example, the above examples show the configurations wherein the reference axes of all the reflecting mirrors M1-M6 in the projection optical system PL disagree with the reference optical axis Ax, but, without having to be limited to this, it is also possible, for example, to adopt a configuration wherein only one set of reflecting mirrors have their reference axis disagreeing, or a configuration wherein the reference axes of all the reflecting mirrors disagree. Furthermore, the above examples show the configurations wherein the reflecting surfaces of all the reflecting mirrors M1-M6 in the projection optical system PL are of the rotationally-symmetric aspheric shape, but, without having to be limited to this, it is also possible, for example, to adopt a configuration wherein only one set of reflecting mirrors are of the rotationally-symmetric aspheric shape, or a configuration wherein none of the reflecting mirrors is of the rotationally-symmetric aspheric shape.

The number of reflecting mirrors in the projection optical system PL is not limited to the number (6) in the above embodiment and examples.

It is also possible to adopt a configuration wherein the first surface (pattern surface R1) and the second surface (exposure surface W1) are parallel to each other and wherein the normals to these first and second surfaces are not parallel to the reference optical axis Ax.

The invention is not limited to the fore going embodiments but various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined.

What is claimed is:

1. A reflective projection optical system which projects an image of a first surface onto a second surface with reflected radiation on the first surface illuminated with an illumination beam from an illumination optical system,
the projection optical system comprising: a first optical unit comprising at least one reflecting optical element; and a second optical unit comprising at least one reflecting optical element,
wherein a focal point on the second surface side of the first optical unit substantially agrees with a focal point on the first surface side of the second optical unit,
wherein an angle between a normal to the first surface and a principal ray of the illumination beam incident to the first surface is larger than a value of arcsine of a numerical aperture on the first surface side of the reflective projection optical system, and
wherein all the optical elements in the projection optical system are located outside an extension surface of a ray group defining an outer edge of the illumination beam incident to the first surface.

2. The reflective projection optical system according to claim 1, wherein reference axes of at least one set of reflecting optical elements out of all the reflecting optical elements of the first optical unit and the second optical unit disagree with each other.

3. The reflective projection optical system according to claim 2, wherein at least one set of reflecting optical elements out of all the reflecting optical elements of the first optical unit and the second optical unit are rotationally-symmetric aspheric mirrors, and wherein the reference axes thereof are axes of rotational symmetry of the respective aspheric mirrors.

4. The reflective projection optical system according to claim 3, the reflective projection optical system being substantially telecentric on both of the first surface side and the second surface side.

5. The reflective projection optical system according to claim 4, wherein a direction of a normal to the first surface disagrees with a direction of a normal to the second surface.

6. The reflective projection optical system according to claim 5, the reflective projection optical system including an aperture stop between the first optical unit and the second optical unit.

7. The reflective projection optical system according to claim 6, the reflective projection optical system consisting of six reflecting mirrors, wherein the aperture stop is arranged between the second reflecting mirror and the third reflecting mirror along an optical path from the first surface.

8. The reflective projection optical system according to claim 1, the reflective projection optical system being substantially telecentric on both of the first surface side and the second surface side.

9. The reflective projection optical system according to claim 8, wherein a direction of a normal to the first surface disagrees with a direction of a normal to the second surface.

10. The reflective projection optical system according to claim 9, the reflective projection optical system including an aperture stop between the first optical unit and the second optical unit.

11. The reflective projection optical system according to claim 1, wherein a direction of a normal to the first surface disagrees with a direction of a normal to the second surface.

12. The reflective projection optical system according to claim 11, the reflective projection optical system including an aperture stop between the first optical unit and the second optical unit.

13. The reflective projection optical system according to claim 1, the reflective projection optical system including an aperture stop between the first optical unit and the second optical unit.

14. The reflective projection optical system according to claim 13, the reflective projection optical system consisting of six reflecting mirrors, wherein the aperture stop is arranged between the second reflecting mirror and the third reflecting mirror along an optical path from the first surface.

15. An exposure apparatus which projects an image of a first surface onto a second surface, the exposure apparatus comprising:
an illumination optical apparatus to illuminate the first surface; and
the reflective projection optical system as set forth in claim 1.

16. The exposure apparatus according to claim 15, further comprising a radiation source for supplying EUV radiation to the illumination optical apparatus.

17. A device manufacturing method comprising:
preparing a photosensitive substrate;
arranging the photosensitive substrate on the second surface in the exposure apparatus as set forth in claim 15, and projecting an image of a predetermined pattern located at the first surface, onto the photosensitive substrate to effect exposure thereof;
developing the photosensitive substrate onto which the image of the pattern on the mask has been projected, to form a mask layer in a shape corresponding to the pattern on a surface of the photosensitive substrate; and
processing the surface of the photosensitive substrate through the mask layer.

18. A projection method for projecting an image of a first surface onto a second surface with reflected radiation on the first surface illuminated with an illumination beam from an illumination optical system, the projection method comprising:
leading the reflected radiation on the first surface to a first optical unit comprising at least one reflecting optical element;
leading radiation from the first optical unit to a second optical unit comprising at least one reflecting optical element; and
projecting the image of the first surface onto the second surface with radiation from the second optical unit;
wherein a focal point on the second surface side of the first optical unit substantially agrees with a focal point on the first surface side of the second optical unit,
wherein an angle between a normal to the first surface and a principal ray of the illumination beam incident to the first surface is larger than a value of arcsine of a numerical aperture on the first surface side of the reflective projection optical system, and
wherein all the optical elements in the projection optical system are located outside an extension surface of a ray group defining an outer edge of the illumination beam incident to the first surface.

19. An exposure method for projecting an image of a first surface onto a second surface, the exposure method comprising:
illuminating the first surface; and
projecting the image of the first surface onto the second surface, using the projection method as set forth in claim 18.

20. A device manufacturing method comprising:
preparing a photosensitive substrate;
arranging the photosensitive substrate on the second surface, and projecting an image of a predetermined pattern located at the first surface, onto the photosensitive substrate to effect exposure thereof by using the exposure method as set forth in claim 19;
developing the photosensitive substrate onto which the image of the pattern on the mask has been projected, to form a mask layer in a shape corresponding to the pattern on a surface of the photosensitive substrate; and
processing the surface of the photosensitive substrate through the mask layer.
